(19) United States
(12) Patent Application Publication
(10) Pub. No.: US 2003/0205206 A1
(43) Pub. Date: Nov. 6, 2003

(54) Dog bone holder

(76) Inventors: Sal Natale, Duarte, CA (US); Elaine Natale, Duarte, CA (US)

Correspondence Address: LITTMAN LAW OFFICES, LTD., P.O. BOX 15035 CRYSTAL CITY STATION, ARLINGTON, VA, 22215, US

(21) Appl. No.: 10/428,859

(22) Filed: May 5, 2003

Related U.S. Application Data
(60) Provisional application No. 60/377,615, filed on May 6, 2002.

(51) Int. Cl. A01K 29/00

(52) U.S. Cl. 119/709

(57) ABSTRACT

A dog bone or chew toy holder having a cylindrical anchoring base having a top wall, a bottom end, and a sidewall extending between the top wall and the bottom end. The top and side walls are preferably made of plastic, but any durable resilient material will suffice. The anchoring base is filled with concrete or other dense material. A rod with a top end and bottom is anchored in the base and extends vertically from the top wall of the base along its central axis. The rod is threaded and a nylon dog bone or other chew toy is attached to the top of the rod, preferably beyond the base. The dog bone or chew toy is preferably mounted near one end thereof. A cylindrical sheath covers the rod between the bone and the top wall of the base. A rim extends from the bottom end of the base.

### CROSS-REFERENCE TO RELATED APPLICATION

This application claims the benefit of U.S. Provisional Patent Application Serial No. 60/377,615, filed May 6, 2002.

### BACKGROUND OF THE INVENTION

1. Field of the Invention

The present invention relates to pet toys. More particularly, the present invention relates to holders for dog bone or chew toys for dogs

2. Description of Related Art

One of the most widely accepted theories concerning the evolution of canis familiaris, or the domesticated dog, is that they evolved from wolves that had gathered around primitive human encampments to take advantage of cast aside bones. It seems that since that time dogs have not lost their affinity for bones, and for that matter, all things chewable.

Chewing is not only a favored pass time; it actually is an important part of a dog's development. While it may seem that puppies just have fun chewing up everything in sight, chewing actually is necessary for correct jaw and tooth development. Without sufficient chewing as a puppy a dog's teeth would not fuse properly into its jaw.

As we humans have more closely incorporated dogs into our lives and homes, some of these chewing habits can become bothersome. Whether it be from the continual burying of toys in flower beds or the mess resulting from a bone chewed in the living room, there is a need for a chewable dog toy that is easily accessible to dogs and that will stay in a fixed location.

Ordinarily dogs use their front paws to manipulate items they are chewing. There are, however, certain situations in which dogs are prevented from normally manipulating bones. For example, some dogs must wear a protective, Elizabethan type collar to prevent them from licking or biting injured body parts. These collars also prevent dogs from properly manipulating chew toys to put them in position for proper chewing. The situation is exasperated when a dog must undergo joint or limb surgery that limits their mobility for a long period of time. In such situations, chewing can be the dog's only form of recreation. The present invention allows dogs to get the therapeutic benefits of chewing even when denied the use of their front paws.

U.S. Pat. No. 6,311,639 to Stickney teaches a dog bone holder that is cubical in shape with an opening at the top or bottom or both. A channel is cut in one or more of the sides. A bone is placed in the channel for a dog to chew upon. The '639 patent is distinguishable from the present invention because the present invention holds the pet toy on the end of a rod, with the rod being embedded in a heavy base.

None of the above inventions and patents, taken either singly or in combination, is seen to describe the instant invention as claimed.

### SUMMARY OF THE INVENTION

The present invention is a dog bone holder having a cylindrical anchoring base having a top wall, a bottom end, and a sidewall which extends between the top wall and the bottom end. The top and side walls are preferably made of plastic, but any durable resilient material will suffice. The anchoring base is filled with concrete or other dense material. A rod with a top end and bottom is anchored in the base and extends vertically from the top wall of the base along its central axis. The rod is threaded and a nylon dog bone or other chew toy is attached to the top of the rod, preferably beyond the base. The dog bone or chew toy is preferably mounted near one end thereof. A cylindrical sheath covers the rod between the bone and the top wall of the base. A rim extends from the bottom surface of the base.

Accordingly, it is a principal object of the invention to provide a device capable of holding a bone or chew toy for an animal.

It is a further object of the invention to provide a device that will hold a bone or chew toy in such a way that will not injure the dog chewing the toy.

Still another object of the invention is to provide a device having a heavy base that will secure a bone or chew toy in a particular location, and that will ensure that the device remains upright.

Yet another object of the invention is to provide a device as above, the bone or chew toy being mounted so as to extend outward from the base such that a dog wearing a protective conical collar may reach the chew toy with its mouth for chewing thereon.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a dog bone holder according to the present invention.

FIG. 2 is a perspective view of a dog bone holder with a section removed.

FIG. 3 is a perspective view of a second embodiment of a dog bone holder according to the present invention.

FIG. 4 is a perspective view of a third embodiment of a dog bone holder according to the present invention holding a chew toy instead of a bone.

Similar reference characters denote corresponding features consistently throughout the attached drawings.

### DETAILED DESCRIPTION OF THE PREFERRED EMBODIMENTS

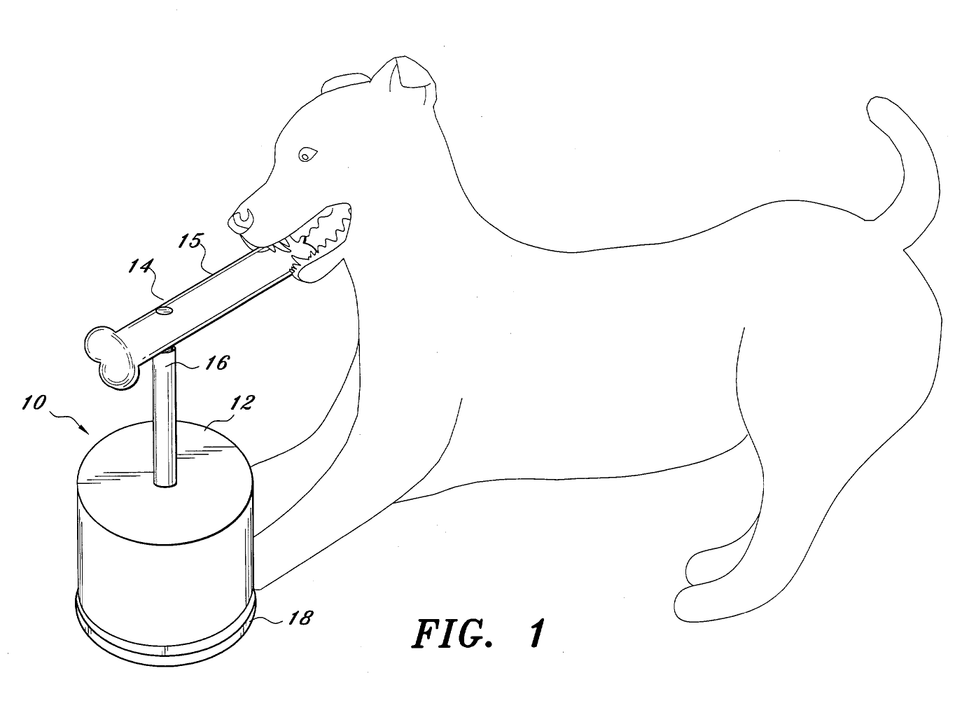

The present invention, as shown in FIG. 1, is a dog bone or chew toy holder 10. The device has a cylindrical base 12 with a top wall, a bottom end, and a sidewall and is circular in cross section. The top and sidewalls are preferably made of plastic but any durable resilient material will suffice and has a tapped vertical bore therethrough. A rod 14 with a top and bottom extends from the top wall of the base 12. The rod 14 is threaded and a dog bone 15 is screwed onto the top of the rod 14. The bone 15 is preferably constructed of nylon but any resilient, durable, chewable, nontoxic material may be used. A cylindrical sheath 16 covers the rod 14 between the bone 15 and the top wall of the base 12. A rim 18 extends from the bottom surface of the base. The rim is optional and functions to provide a dog purchase against the base 12 with a front claw.

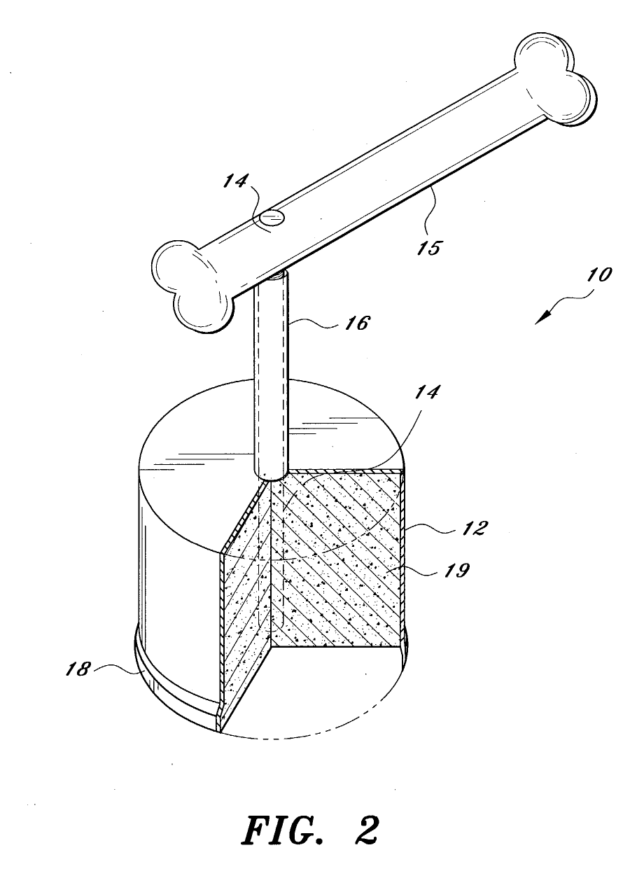

FIG. 2 illustrates a side perspective view of the dog bone holder 10. The rod 14 can be seen to extend nearly to the bottom end of the base 12. Internally, the base 12 is preferably composed of cement 19 or any other dense material capable of securing the rod 14.

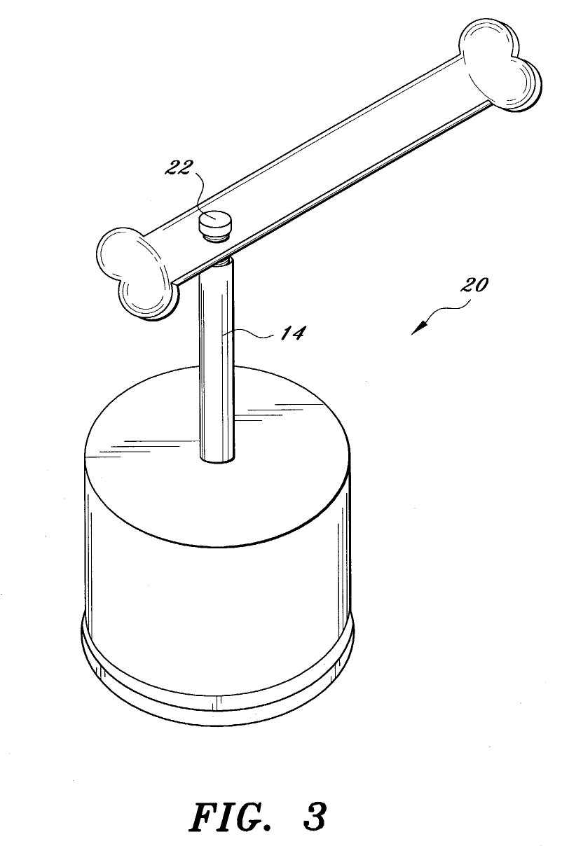

FIG. 3 is a perspective view of a second embodiment of the present invention. The second embodiment of the holder 20 differs from the first embodiment in that it has a cap 22 threadingly attached to the top of the rod 14. The cap 22 is preferably composed of resilient plastic or other polymer in order to protect a dog's teeth. The bone has a vertical bore therethrough for mounting over the threaded rod upper end is secured thereon by the cap.

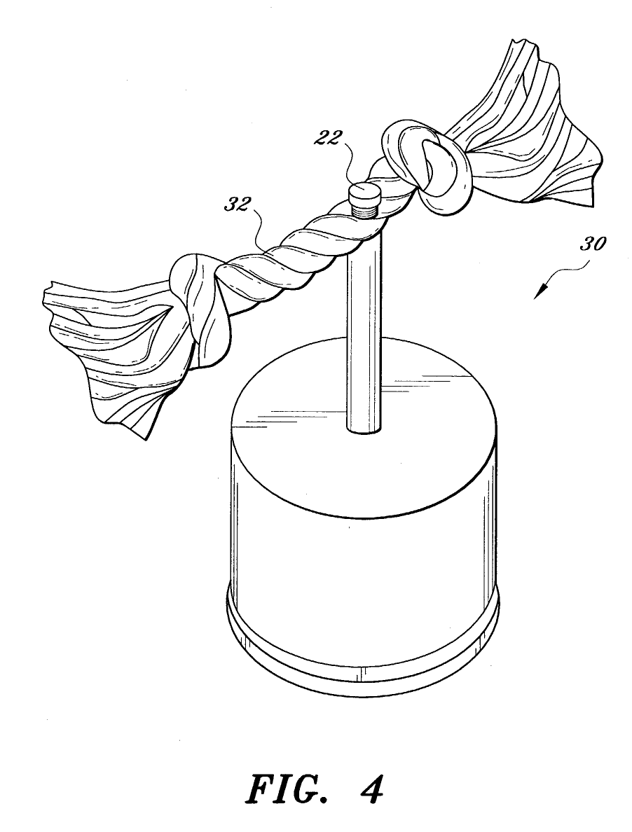

FIG. 4 illustrates a third embodiment of the present invention. In the third embodiment of the holder 30 the bone 15 of the second embodiment 20 has been replaced with a rope 32. The rope 32 is preferably constructed of cotton or nylon, but any suitable chewable, nontoxic material may be used.

As seen in the Figures, the bone or chew toy is preferably mounted near a support end, thereof, on the above holder embodiments so that the bone or chew toy extends outward from the base to a chewing end. This makes the bone or chew toy accessible to a dog wearing a conical collar such as those commonly used by a veterinarian to keep the dog from licking a wound while healing, the collar extending outward, forward of the neck of the dog. This collar prevents the dog from holding a bone or chew toy with its front paws. The inventive holder allows access to the bone or chew toy to chew while wearing such a collar. The inventive holder is also useful to prevent a dog from burying the bone or chew toy in the yard of its owner.

It is to be understood that the present invention is not limited to the sole embodiments described above, but encompasses any and all embodiments within the scope of the following claims.

We claim:

1. A dog bone or chew toy holder, comprising:
an anchor base having a top wall, a sidewall and a bottom end;
a vertically disposed rod having an upper end, said rod extending upward from said top wall;
said vertically disposed rod having means for supporting a dog bone or other dog chew toy at said rod upper end.

2. The dog bone or chew toy holder of claim 1, said means for supporting a dog bone or other dog chew toy being a threaded end on said vertically disposed rod upper end for receiving a dog bone or chew toy, said vertically disposed rod having a surrounding sheath extending between said base upper wall and said bone or chew toy.

3. The dog bone or chew toy holder of claim 2, wherein said dog bone or chew toy has a tapped vertical bore therethrough for threaded connection with said threaded end said dog.

4. The dog bone or chew toy holder of claim 3, wherein said dog bone or chew toy is elongated in configuration having a mounting end and a chewing end and said tapped vertical bore is located near said mounting end one end thereof, said dog bone or chew toy being generally horizontally disposed.

5. The dog bone or chew toy holder of claim 4, wherein said chewing end extends horizontally beyond said anchor base sidewall.

6. The dog bone or chew toy holder of claim 2, wherein said dog bone or chew toy has a vertical bore therethrough, said vertical bore extending down over said threaded upper end, said means for supporting said dog bone or chew toy further comprising a threaded cap so configured as to retain said dog bone or chew toy on said vertical rod upper end when said threaded cap is threadingly engaged with said vertical rod threaded upper end.

7. The dog bone or chew toy holder of claim 6, wherein said dog bone or chew toy is elongated in configuration having a mounting end and a chewing end and said tapped vertical bore is located near said mounting end one end thereof, said dog bone or chew toy being generally horizontally disposed.

8. The dog bone or chew toy holder of claim 7, wherein said chewing end extends horizontally beyond said anchor base sidewall.

9. The dog bone or chew toy holder of claim 8, wherein said chew toy is a multi-stranded rope segment and said multi-stranded rope segment is mounted over said top end through an opening between strands of said rope segment.

10. The dog bone or chew toy holder of claim 5, said anchor base being cylindrical in shape, and vertically disposed, said vertically disposed rod extending axially downward into said anchor base, said anchor base having a dense material therein, said vertically disposed rod being secured within said dense material.

11. The dog bone or chew toy holder of claim 10, wherein said anchor base has a rim at its lower end, said dense material is concrete, and said upper wall and sidewall is made of plastic.

12. The dog bone or chew toy holder of claim 8, said anchor base being cylindrical in shape, and vertically disposed, said vertically disposed rod extending axially downward into said anchor base, said anchor base having a dense material therein, said vertically disposed rod being secured within said dense material.

13. The dog bone or chew toy holder of claim 12, wherein said anchor base has a rim at its lower end, said dense material is concrete, and said upper wall and sidewall is made of plastic.

14. The dog bone or chew toy holder of claim 2, wherein said sheath is cylindrical, having an upper end and a lower end, said base top wall supporting said sheath lower end and said upper end providing vertical support for said dog bone or chew toy.

15. A dog bone or chew toy holder, comprising:
a cylindrical anchor base having a top wall, a sidewall and a bottom end;
a vertically disposed, threaded rod axially disposed in said cylindrical anchor base and extending upward from said top wall to and upper end thereof;
said threaded rod upper end serving as a support for a dog bone or chew toy;
a threaded plastic cap for securing said dog bone or chew toy on said threaded rod upper end;
a cylindrical sheath extending between said top wall and said dog bone or chew toy on said threaded rod upper end.

16. The dog bone or chew toy holder according to claim 15, wherein said dog bone or chew toy is elongated and horizontally disposed, having a support end and a chewing end, said chewing end extending beyond supported such that said chewing end extends beyond said side wall.

17. The dog bone or chew toy holder according to claim 16 wherein said threaded rod is disposed in concrete, said top wall and said sidewall being plastic.

18. The dog bone or chew toy holder of claim 17, wherein said dog bone or chew toy has a vertically disposed, tapped bore configured to screw onto said upper end of said threaded vertical rod.

19. The dog bone or chew toy holder of claim 18, wherein said dog bone or chew toy has a vertically disposed, throughbore mounted over said upper end of said threaded rod, said threaded cap being screwed onto said upper end so as to secure said dog bone or chew toy thereon.

20. The dog bone or chew toy holder of claim 19, in combination with a dog bone or chew toy having a support end and a chewing end and is made of nylon.
